(19) United States
(12) Patent Application Publication
(10) Pub. No.: US 2020/0116093 A1
(43) Pub. Date: Apr. 16, 2020

(54) NOX FORMATION PREDICTION FOR IMPROVED CATALYTIC CONVERTER CONTROL

(71) Applicant: GM GLOBAL TECHNOLOGY OPERATIONS LLC, Detroit, MI (US)

(72) Inventors: Jianyang Geng, South Lyon, MI (US); Jeffry A. Helmick, Oxford, MI (US); Rafat F. Hattar, Royal Oak, MI (US)

(21) Appl. No.: 16/156,009

(22) Filed: Oct. 10, 2018

(51) Int. Cl. F02D 41/02; F01N 11/00; F01N 3/10; B01D 53/94; F01N 3/20

(52) U.S. Cl. CPC F02D 41/0235; F01N 11/007; F01N 3/101; B01D 53/9454; F02D 2200/0414; F01N 3/20; F02D 2200/024; F02D 2200/101; B01D 53/9495

(57) ABSTRACT

Methods of treating exhaust in a vehicle, and exhaust systems for a vehicle, are disclosed. Example methods may include providing a catalytic converter in an exhaust tailpipe and an oxygen sensor downstream of the catalytic converter. The catalytic converter may be configured to reduce a concentration of a nitrogen oxide (NOₓ) present in an exhaust flow through the catalytic converter. The method further includes predicting an increase in an oxygen concentration within the catalytic converter based upon at least one or more real-time vehicle operating parameters, wherein the increase is predicted before a corresponding increase in oxygen concentration is measured by the downstream oxygen sensor. The method may also include adjusting an air-fuel ratio of an engine of the vehicle based upon the predicted increase in oxygen concentration, thereby at least partially preventing the corresponding increase in the oxygen concentration.

### INTRODUCTION

Catalytic converters may reduce emissions, including nitrogen-oxides (NOx), in an exhaust flow from an internal combustion engine. Typical three-way catalytic converters generally contain a catalyst material(s) which reduces NOx to nitrogen (N₂), oxidizes carbon-monoxide (CO) to carbon-dioxide (CO₂), and oxidizes unburnt hydrocarbons (HC) to carbon-dioxide and water (H₂O). Oxygen (O₂) is a required input to the catalytic converter, and thus the amount of oxygen within the catalytic converter must be controlled during vehicle operation. Oxygen levels outside a given control window will result in at least some NOx emissions slipping past the converter, and potentially being exhausted to the environment. Thus, a catalytic converter control system must generally monitor oxygen levels in the catalytic converter closely.

Formation of NOx in a vehicle exhaust system is highly transient and dependent upon conditions that change constantly during vehicle operation. Thus, current approaches to monitoring oxygen levels in or flowing from the catalytic converter generally rely upon direct measurements of the exhaust system. For example, an oxygen sensor is typically positioned immediately downstream of the catalytic converter to determine oxygen levels in the catalytic converter and/or the exhaust flow. However, this measurement necessarily lags behind the oxygen level in the converter at the time the downstream measurement is taken, even if the sensor is positioned immediately adjacent the converter. In other words, by the time the downstream sensor observes a drop in oxygen level and the control system intervenes, some NOx emissions will already have been produced or emitted from the converter.

Accordingly, there is a need for an improved method and system for reducing NOx emissions with a catalytic converter.

### SUMMARY

In at least some example illustrations, a method of treating exhaust in a vehicle includes providing a catalytic converter in an exhaust tailpipe and an oxygen sensor downstream of the catalytic converter. The catalytic converter may be configured to reduce a concentration of a nitrogen oxide (NOₓ) present in an exhaust flow through the catalytic converter. The method further includes predicting an increase in an oxygen concentration within the catalytic converter based upon at least one or more real-time vehicle operating parameters, wherein the increase is predicted before a corresponding increase in oxygen concentration is measured by the downstream oxygen sensor. The method may also include adjusting an air-fuel ratio of an engine of the vehicle based upon the predicted increase in oxygen concentration, thereby at least partially preventing the corresponding increase in the oxygen concentration.

In some examples, adjusting the air-fuel ratio of the engine enriches the air-fuel ratio of the engine.

At least some example methods include adjusting the air-fuel ratio before the corresponding increase in oxygen concentration occurs.

In some examples, the one or more real-time vehicle operating parameters include at least a pressure ratio of the engine, an air mass per cylinder of the engine, an engine speed, and the air-fuel ratio of the engine. In a subset of these examples, the one or more real-time vehicle operating parameters additionally include at least an upstream oxygen temperature, a rate of change in the engine pressure ratio, a rate of change of the air mass per cylinder of the engine, and a rate of change of the engine speed.

In some example methods, the predicted oxygen concentration is modeled based upon an emission test associated with the engine. The emission test may include, in some example approaches, correlating a change in NOx production with the one or more real-time vehicle operating parameters. In some of these examples, the one or more real-time vehicle operating parameters include at least one of a pressure ratio of the engine, an air mass per cylinder of the engine, an engine speed, and the air-fuel ratio of the engine. In still other example methods, the one or more real-time vehicle operating parameters additionally include at least an upstream oxygen temperature, a rate of change in the engine pressure ratio, a rate of change of the air mass per cylinder of the engine, and a rate of change of the engine speed.

In some example approaches, the adjusting of the air-fuel ratio of the engine of the vehicle prevents the corresponding increase in the oxygen concentration.

In at least some example methods, the adjusting of the air-fuel ratio of an engine of the vehicle based upon the predicted increase in oxygen concentration reduces an increase in NOx concentration caused by the corresponding increase in oxygen concentration.

In another example of a method of treating exhaust in a vehicle, the method includes providing a catalytic converter in an exhaust tailpipe and an oxygen sensor downstream of the catalytic converter, with the catalytic converter configured to reduce a concentration of a nitrogen oxide (NOₓ) present in an exhaust flow through the catalytic converter. The method may further include predicting an increase in an oxygen concentration within the catalytic converter based upon one or more real-time vehicle operating parameters before a corresponding increase in oxygen concentration is measured by the downstream oxygen sensor, and at least partially preventing the increase in oxygen concentration before the corresponding increase in oxygen concentration occurs, based upon the predicted increase in oxygen concentration using the one or more real-time vehicle operating parameters.

In some examples, an exhaust system for a vehicle includes a catalytic converter positioned in an exhaust tailpipe, the catalytic converter configured to reduce a concentration of a nitrogen-oxide (NOₓ) present in an exhaust flow through the catalytic converter, and an oxygen sensor in the tailpipe, the oxygen sensor positioned downstream of the catalytic converter. The exhaust system may further include a processor in communication with at least one real-time vehicle operating parameter measured at the vehicle, the processor configured to predict an increase in an oxygen concentration within the catalytic converter based upon the at least one real-time vehicle operating parameter before a corresponding increase in oxygen concentration is measured by the downstream oxygen sensor, the processor configured to adjust an air-fuel ratio of an engine of the vehicle based upon the predicted increase in oxygen concentration.

In some example exhaust systems, the processor is configured to respond to the predicted oxygen concentration increase by enriching the air-fuel ratio of the engine.

In one example approach, the processor may be configured to respond to the predicted oxygen concentration increase by adjusting the air-fuel ratio of the engine before the corresponding increase in oxygen concentration occurs.

In at least some examples, the predicted oxygen concentration is modeled based upon an emission test associated with the engine, wherein the emission test correlates changes in NOx production with the one or more real-time vehicle operating parameters. In a subset of these examples, the correlated changes in NOx production are stored in a memory of the processor.

In some example exhaust systems, the one or more real-time vehicle operating parameters include at least one of a pressure ratio of the engine, an air mass per cylinder of the engine, an engine speed, and the air-fuel ratio of the engine. In a subset of these example exhaust systems, the one or more real-time vehicle operating parameters additionally include at least an upstream oxygen temperature, a rate of change in the engine pressure ratio, a rate of change of the air mass per cylinder of the engine, and a rate of change of the engine speed.

In at least some example exhaust systems, the catalytic converter is configured to reduce NOx concentration in an exhaust flow received from a gasoline engine.

### BRIEF DESCRIPTION OF THE DRAWINGS

One or more embodiments of the invention will hereinafter be described in conjunction with the appended drawings, wherein like designations denote like elements, and wherein:

FIG. 1 is a schematic illustration of a vehicle having an exhaust system, according to one example approach;

FIG. 2 is a schematic illustration of a control methodology for the vehicle of FIG. 1, according to an example; and

FIG. 3 is a process flow diagram for a method of treating an exhaust flow in a vehicle, according to one example.

### DETAILED DESCRIPTION

Example methods and exhaust systems for a vehicle may generally employ a predictive approach with respect to changes in NOx levels or concentrations in a catalytic converter. More particularly, one or more real-time vehicle operating parameters may be used to predict deviations, e.g., expected increases, in NOx production. In some example approaches, a model trained with emission lab data may be used to proactively predict high NOx formation situations in the engine based upon the real-time operating parameters. Accordingly, when a high likelihood of increased NOx formation is predicted, proactive measures may be taken to reduce NOx emissions. In some examples that will be discussed further below, an example processor may send a signal based on the predicted increase in NOx formation, and the signal may be used to adjust engine operating conditions, e.g., an air-fuel ratio of the engine. As a result, the predicted increase in NOx formation is at least partially reduced, or even eliminated. In contrast to example approaches using a proactively forecast NOx increase, previous approaches would not intervene until conditions at the catalytic converter indicating increased NOx formation, e.g., relatively low oxygen levels, were actually detected by the sensors present in/adjacent the catalytic converter.

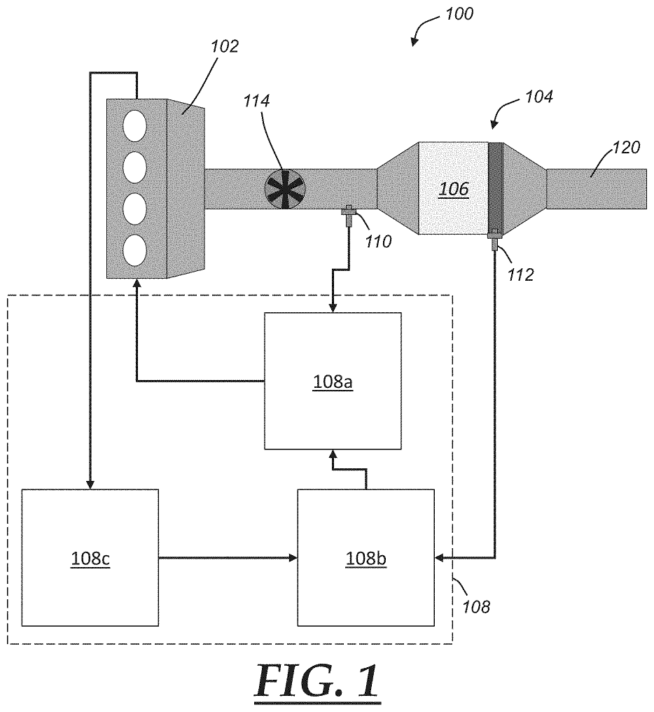

Turning now to FIG. 1, an example vehicle 100 is illustrated. Vehicle 100 may have an internal combustion engine 102 for providing motive power to one or more wheels (not shown) of the vehicle 100. The engine 102 may be a gasoline engine, although the concepts disclosed herein are applicable to other combustion engine types where NOx is produced as a combustion byproduct, e.g., diesel engines. The vehicle 100 may rely solely upon the engine 102 for providing power to the vehicle 100, or may alternatively include other power sources, e.g., an electric motor-generator. Thus, the vehicle 100 may be powered exclusively by the engine 102, or may be a hybrid vehicle employing other power sources in addition to the engine 102.

The vehicle 100 may include an exhaust system 104 receiving an exhaust flow from the engine 102. The exhaust system 104 may include one or more pipes or other means of directing exhaust flow from the engine 102 and into the ambient air around the vehicle or otherwise to the atmosphere. Moreover, the exhaust system 104 may include various components for reducing emissions in the exhaust flow before expelling the treated exhaust flow to the atmosphere. As illustrated in FIG. 1, the exhaust system 104 may expel the exhaust flow to a tailpipe 120, which may include one or more mufflers for reducing noise associated with the exhaust flow. The tailpipe 120 may, in turn, expel the exhaust flow into the ambient atmosphere about the vehicle.

The exhaust system 104 may include one or more aftertreatment devices or other components configured to reduce emissions, e.g., nitrogen oxide (NOx) emissions. Reduction of NOx may be accomplished by any devices or systems that are convenient and are not limited to the specific types or examples discussed herein or illustrated in FIG. 1. The example exhaust system 104 illustrated includes a three-way catalytic converter 106, which contains a catalyst material that (1) reduces NOx to nitrogen (N₂), (2) oxidizes carbon-monoxide (CO) to carbon-dioxide (CO₂), and (3) oxidizes unburnt hydrocarbons (HC) to carbon-dioxide and water (H₂O). Nevertheless, the catalytic converter 106 may be any type of catalytic converter that reduces NOx present in the exhaust flow, and thus example illustrations are not limited to those employing a three-way converter. In addition to the converter 106, the exhaust system 104 may include any other additional components for reducing emissions or particulates emitted from the engine 102 that are convenient, such as filters, screens, mufflers, or the like.

The exhaust flow from the engine 102 may generally contain sufficient amounts of oxygen necessary for the reactions in the catalytic converter 106. Concentration of oxygen in the exhaust gases from engine 102, and in turn a concentration of oxygen in the converter 106, may vary depending on various factors, such as the engine load and amount of exhaust flow through the exhaust system 104. The catalyst activity of the converter 106 may also increase with temperature. Typically, a minimum exhaust temperature is necessary for the catalyst in the converter 106 to “light off” and be effective at reducing NOx emissions in the exhaust flow. At elevated temperatures, conversions depend on the catalyst size and design, and generally increase with temperature. In an example, a minimum exhaust temperature of about 200 degrees Celsius (C) is needed in order for the catalyst of the converter 106 to be effective.

The air-fuel ratio of the engine 102 may also affect production of NOx and the ability of the converter 106 to reduce NOx emissions. Typically, the engine 102 may be operated within a relatively narrow band of air-fuel ratios near a stoichiometric point, and efficiency of the converter 106 generally falls when the engine 102 is operated outside of a band above or below the stoichiometric point. When the engine 102 is operated under a “lean” burn where the air-fuel ratio is below the stoichiometric point, the exhaust flow typically contains excess oxygen, thereby inhibiting the effectiveness of the converter 106 at reducing NOx emissions. Additionally, under “rich” conditions where the air-fuel ratio is above stoichiometric point, unburned fuel may consume some or all of the available oxygen prior to the exhaust flow reaching the catalyst, reducing oxygen available for the oxidation function. The converter 106 may store some oxygen therein, which may provide a buffer for temporary reductions in oxygen levels in an exhaust flow received from the engine 102.

The exhaust system 104 may include any sensor(s) that may be needed for monitoring conditions, e.g., temperature, pressure, or the like, which may be communicated to a controller 108. The exhaust system 104 may include, for example, a first or upstream oxygen (O₂) sensor 110 that is positioned immediately upstream from the catalytic converter 106. A second or downstream sensor 112 may similarly detect levels or concentration of oxygen at a position immediately downstream of the catalytic converter 106. Temperature sensors may include one or more thermocouples configured to detect temperature of the exhaust flow at various locations throughout the exhaust system. For example, a thermocouple 114 may be positioned immediately downstream from the engine 102 or exhaust manifold. The thermocouple 114 may thus measure a temperature of the exhaust flow as it is emitted from the engine 102 and/or exhaust manifold of the engine 102.

The controller 108 may generally monitor one or more real-time vehicle parameters associated with NOx production and/or the exhaust system 104, and adjust aspects of operation of the vehicle 100. Merely as one example, the controller 108 may be an engine control module (ECM) that adjusts an air-fuel ratio of the engine 102 in response to detected conditions. The controller 108 may therefore be in communication with the components of the exhaust system 104, the engine 102, or other components of the vehicle 100. The controller 108 may generally monitor vehicle operating parameters in real-time. For example, the controller 108 may monitor and/or determine:
an upstream oxygen temperature (e.g., as measured at the upstream oxygen sensor 110);
a pressure ratio of the engine 102;
a derivative or rate of change of the pressure ratio of the engine 102;
a mass airflow of the engine 102 (in total or per cylinder);
a derivative or rate of change of the mass airflow of the engine 102;
a speed of the engine, e.g., in rotations per minute (RPM);
a derivative or rate of change of the engine speed; and
the air-fuel ratio of the engine.
   Any other parameters of the engine 102 and/or the vehicle 100 may be monitored or employed that are convenient.

As noted above, the controller 108 may be an ECM of the engine 102. Alternatively, the controller 108 may be a separate controller, or may be embodied in one or more separate controllers of the vehicle 100. The controller 108 may generally a processor and a computer-readable memory, e.g., a non-transitory computer-readable memory, which include instructions that, when executed by the processor, are configured to monitor real-time vehicle parameters, and control aspects of the engine 102, exhaust system 104, and the vehicle 100 discussed herein.

In the example illustrated in FIG. 1, the controller 108 includes first and second fueling controllers or subcontrollers 108a, 108b, as well as a NOx formation model 108c. The first and second fueling controllers 108a and 108b may generally cooperate to monitor and control the air-fuel ratio of the engine 102, in addition to any other operating parameters of the engine 102 that are convenient. The controllers 108a, 108b need not be embodied in separate memories and/or processors, and the designation as separate controllers 108a and 108b is merely for the sake of clarity with respect to the separate functions of each in the example illustrations herein. In one example, the first fueling controller 108a is a proportional-integral-derivative (PID) controller that adjusts injector fueling to control an equivalence ratio (i.e., a ratio of the actual air-fuel ratio of the engine 102 to the stoichiometric air-fuel ratio of 14.7:1) of the engine 102. The first fueling controller 108a may receive feedback from the upstream oxygen sensor 110 in monitoring the air-fuel ratio of the engine 102. The second fueling controller 108b may be a proportional-integral (PI) controller that adjusts a target equivalence ratio of the engine 102 based upon oxygen levels as measured by the downstream oxygen sensor 112, using a calibrated oxygen-level window. Generally, the first fueling controller 108a may provide a faster control response than the second fueling controller 108b, because the first fueling controller 108a is based on feedback of a continuous wide-range air-fuel (WRAF) oxygen sensor 110. In other words, the first fueling controller 108a generally makes control corrections in real time, and outputs from the first fueling controller 108a are directly used to adjust injector fuel command at the engine 102. By comparison, the second fueling controller 108b is relatively slower because it is based on an input received from the downstream oxygen sensor 112, and the output of the second fueling controller 108b is used to adjust a fueling target used by the first fueling controller 108a (i.e., the second fueling controller 108b does not make adjustments directly to the engine 102). The second fueling controller 108b may be configured to output an adjusted “feedforward” command (to the first fueling controller 108a) upon receiving an output flag from the NOx formation model 108c. The output flag may be used to identify situations where an increase in NOx formation is predicted.

In an example, the NOx formation model 108c may generally monitor one or more vehicle operating parameters in real-time, and determine from those parameters when NOx production is likely to increase. This determination may be made using a fitted model from the one or more parameters, based upon a history associated with the engine 102. For example, an emissions cycle test of the engine 102 may be used to develop a prediction of NOx formation from the monitored parameter(s). In one example, the output of the NOx formation model is a rate of change or derivative of NOx mass output, which is determined based upon the model using the real-time vehicle operating parameters as inputs. Thus, the controller 108 may, based upon the oxygen levels measured by the downstream oxygen sensor 112 and the estimation of NOx from the NOx formation model, predict whether or not a NOx breakthrough (i.e., due to an increase in oxygen concentration) is likely. The controller 108 may, in response, adjust gain sets of the second fueling controller 108b, and select a different (i.e., higher) window to use as a target for the downstream oxygen sensor 112 to calculate a more aggressive equivalence ratio offset for the first fueling controller 108a to follow. In this manner, the air-fuel ratio of the engine 102 may be altered before NOx production associated with the detected real-time parameters slips past the converter 106.

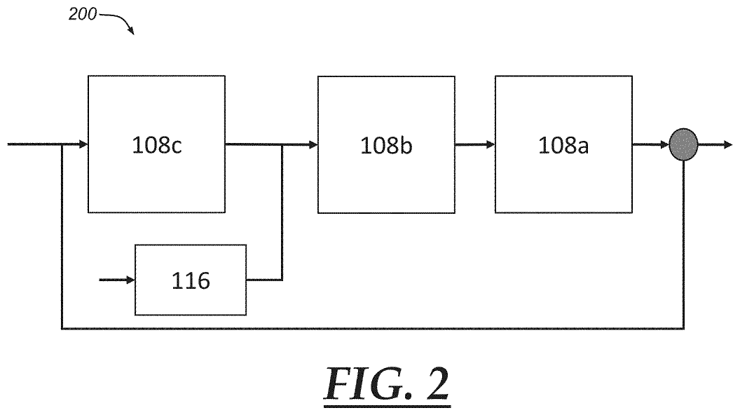

Turning now to FIG. 2, an example control methodology 200, e.g., for use by the controller 108 and the components described above, is illustrated. The control 200 may generally be used to predict increases or relatively high NOx formation based upon vehicle parameter(s) that are monitored by the controller 108 in real-time during engine 102 operation. In the example illustrated, the NOx formation model 108c may receive real-time vehicle operating parameters as inputs. For example, as discussed above, the inputs may include the upstream oxygen temperature (e.g., as measured at the upstream oxygen sensor 110), a pressure ratio of the engine 102, a derivative or rate of change of the pressure ratio of the engine 102, a mass airflow of the engine 102 (in total or per cylinder), a derivative or rate of change of the mass airflow of the engine 102, a speed of the engine, e.g., in rotations per minute (RPM), a derivative or rate of change of the engine speed and the air-fuel ratio of the engine.

It should be noted that the NOx formation model may be consumed by other system level interactions. For example, when an integral of d/dt(RINOXM) over a past window of time exceeds a predetermined amount, the controller 108 may prevent the engine 102 from engine functions that may negatively affect NOx formation, e.g., by preventing the engine 102 from using a Deceleration Fuel Cut-Off (DFCO; i.e., when the engine is not fueled during deceleration under certain conditions) or temporary engine stop feature (i.e., stopping the engine upon the vehicle stopping momentarily, e.g., at a red light or in traffic).

In an example, the NOx formation model 108c is a non-linear Input Output Time Series Neural Network that is trained from emission dyno data associated with the engine 102. The NOx formation model may be a mathematical fitting model, i.e., the model generally does not calculate NOx production or expected output chemically based upon the detected parameters, but rather uses a developed history associated with the engine 102 or vehicle 100 to determine when NOx formation is likely to increase based upon the measured values of the monitored parameter(s). The model may have a memory of a predetermined window of time (e.g., 2 seconds, such that predictions made by the NOx formation model 108c at each moment are based on inputs from last 2 seconds). The NOx formation model 108c generally predicts delta NOx from the engine 102 at each given moment from one or more real-time vehicle operating parameters, such as the eight (8) inputs discussed above. As will be described further below, in other example approaches a different number of inputs may be used.

Example neural network models may be described as follows, with adjustments made for number of neurons (n), delay states (d), and inputs (i):

Y={LW₂[tan h(LW₁·X+B₁)]+B₂}
Where:
Y 1×1 is the output (change rate of mass of engine-out NOx, or d/dt (NOx));
Layer 2 weight matrix or Dim(LW₂)=1×n
Layer 1 weight matrix or Dim(LW₁)=n×(d*i)
Input matrix or X is (d*n)×1
Layer 1 Bias matrix or Dim(B₁)=n×1
Layer 2 Bias matrix or Dim(B₂)=1×1
Values of LW₂, LW₁, B₁, and B₂ may be trained from emission cycle data
   As noted above, the model may be adjusted for different numbers of neurons (n) and inputs (i). Additionally, the variable d, above, describes the delay states as the sample time range divided by sample rate. Merely as one example, sample time may be 2 seconds and sample rate may be 100 milliseconds, resulting in a value of 20 for the delay states. Example neural network models provided herein employed 20 neurons in the models and eight (8) inputs, however any number of neurons or inputs may be used that is convenient. Generally, the more neurons a model has, the more accurate the model will be, however this also results in a need for additional computational power to run the model. Moreover, gains in accuracy generally decrease after reaching a certain number of neurons, and are limited by the inputs themselves (for example, if the input signal does not carry enough information or significance, adding additional neurons typically won't adequately compensate for the deficiency of the input(s)).

Accordingly, in a mathematical representation of an example neural network function using eight (8) different real-time vehicle operating parameters as inputs (i), 20 neurons (n), and 20 delay states (d), the NOx formation model may be described as follows:

Y={LW₂[tan h(LW₁·X+B₁)]+B₂}
Where:
Y 1×1 is the output (change rate of mass of engine out NOx, d/dt (NOx))
LW₂ 1×20 is Layer 2 weight matrix
LW₁ 20×160 is Layer 1 weight matrix
X 160×1 is Input matrix (8 signals*20 delay states=160)
B₁ 20×1 is Layer 1 Bias matrix
B₂ 1×1 is Layer 2 Bias matrix
Value of LW₂, LW₁, B₁, and B₂ are trained from emission cycle data
   In an example of the eight-input model, the real-time vehicle operating parameters employed were (1) an upstream oxygen temperature (i.e., measured near the upstream oxygen sensor 110), (2) a pressure ratio of the engine, (3) an air mass per cylinder of the engine, (4) an engine speed, (5) the air-fuel ratio of the engine, (6) a rate of change in the engine pressure ratio, (7) a rate of change of the air mass per cylinder of the engine, and (8) a rate of change of the engine speed.

In another example approach, where only four (4) inputs (i) are employed with 20 neurons (n) and 20 delay states (d), the NOx formation model may be described as follows:

Y={LW₂[tan h(LW₁·X+B₁)]+B₂}
Where:
Y 1×1 is the output (change rate of mass of engine out NOx, d/dt (NOx))
LW₂ 1×20 is Layer 2 weight matrix
LW₁ 20×80 is Layer 1 weight matrix
X 80×1 is Input matrix (4 signals*20 delay states=80)
B₁ 20×1 is Layer 1 Bias matrix
B₂ 1×1 is Layer 2 Bias matrix
Value of LW₂, LW₁, B₁, and B₂ are trained from emission cycle data
   In an example of the four-input model, the real-time vehicle operating parameters employed were (1) the pressure ratio of the engine 102, (2) an air mass per cylinder of the engine 102, (3) an engine speed of the engine 102, and (4) the air-fuel ratio, e.g., as measured at the upstream oxygen sensor 110.

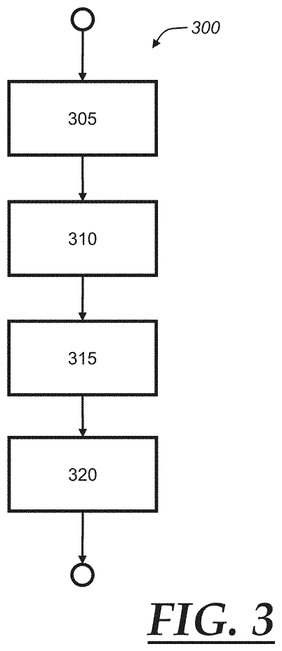

Turning now to FIG. 3, an example process 300 for treating an exhaust flow in a vehicle is illustrated. Process 300 may begin at block 305, where a catalytic converter is provided in an exhaust tailpipe, as well as an oxygen sensor downstream of the catalytic converter. For example, as described above the catalytic converter 106 may be configured to reduce a concentration of a nitrogen oxide (NOx) present in an exhaust flow through the catalytic converter 106. Process 300 may then proceed to block 310.

At block 310, a NOx formation model may be developed, e.g., from an engine emission test cycle associated with the engine. Typically, a model may be developed from multiple emission test cycles run on a given vehicle, engine, or system, although this is not required. As described above, NOx formation model 108c may be developed from emissions cycle data from the engine 102. In this manner, changes in NOx production by the engine 102 may be correlated with one or more real-time vehicle operating parameters. As described above, any vehicle operating parameters may be relied upon for the NOx formation model that are convenient for predicting formation of NOx in the exhaust flow. These parameters, in an illustration, may include (1) an upstream oxygen temperature, (2) a pressure ratio of the engine, (3) an air mass per cylinder of the engine, (4) an engine speed, (5) the air-fuel ratio of the engine, (6) a rate of change in the engine pressure ratio, (7) a rate of change of the air mass per cylinder of the engine, and (8) a rate of change of the engine speed. While the NOx formation model has been found to be particularly accurate when based upon all of these eight (8) parameters, it is possible to achieve sufficient predictive accuracy of the NOx formation model with only a subset of the eight parameters. Merely as one example, a NOx formation model may be employed that uses only (1) a pressure ratio of the engine, (2) an air mass per cylinder of the engine, (3) an engine speed, and (4) the air-fuel ratio of the engine. Moreover, other example approaches to the NOx formation model may employ a smaller or greater number of parameters.

Proceeding to block 315, an increase in an oxygen concentration within the catalytic converter may be predicted based upon at least one or more real-time vehicle operating parameters, with the increase being predicted before a corresponding increase in oxygen concentration is measured by the downstream oxygen sensor. For example, as described above, the eight example parameters may be used to predict high NOx formation, and adjust settings of a controller 108 or components thereof accordingly. Process 300 may then proceed to block 320.

At block 320, an air-fuel ratio of an engine of the vehicle may be adjusted based upon the predicted increase in oxygen concentration. For example, as described above the NOx formation model 108c may use the predicted NOx formation to set a flag triggering an increase in gainset(s) of the fueling controller 108a, thereby modifying the air-fuel ratio of the engine 102 more quickly, and thereby at least partially preventing the NOx formation corresponding to the predicted increase in the oxygen concentration. The air-fuel ratio may be adjusted by enriching the air-fuel ratio. In some examples, the air-fuel ratio may be adjusted before the corresponding increase in oxygen concentration occurs. The adjusting of the air-fuel ratio of the engine of the vehicle may thereby inhibit or prevent entirely the corresponding increase in the oxygen concentration, and thus inhibit or prevent the increase in NOx formation.

The foregoing example predictive methods and systems may generally achieve improved control of the catalytic converter 106, thereby achieving a reduction in NOx emissions in comparison to previous approaches, which employed a reactive approach based upon measured oxygen levels. The reductions in NOx emissions may be of particular benefit to vehicles with more stringent NOx requirements, e.g., Super Ultra-Low Emissions Vehicles (SULEVs) and the like. In an example, tests using the example predictive methodology described above demonstrated an approximate 10% reduction in NOx formation. Moreover, reductions in NOx production may enable increased use of engine stop or defueling procedures. For example, a DFCO or engine stop event may negatively affect NOx production to the extent operating temperature of the converter 106 may be reduced due to the engine 102 being temporarily stopped, creating an increase in NOx production when the engine 102 is restarted. The example predictive methodologies herein may reduce NOx formation to a point that additional fuel cutoff events such as DFCO or engine stops may be used. Accordingly, an increase in fuel economy may be achieved. Alternatively or in addition, the increased efficiency of the converter 106 resulting from the improved performance may allow the use of less catalyst material in the converter 106, thereby reducing cost and/or weight of the converter 106.

It is to be understood that the foregoing is a description of one or more embodiments of the invention. The invention is not limited to the particular embodiment(s) disclosed herein, but rather is defined solely by the claims below. Furthermore, the statements contained in the foregoing description relate to particular embodiments and are not to be construed as limitations on the scope of the invention or on the definition of terms used in the claims, except where a term or phrase is expressly defined above. Various other embodiments and various changes and modifications to the disclosed embodiment(s) will become apparent to those skilled in the art. All such other embodiments, changes, and modifications are intended to come within the scope of the appended claims.

As used in this specification and claims, the terms “e.g.,” “for example,” “for instance,” “such as,” and “like,” and the verbs “comprising,” “having,” “including,” and their other verb forms, when used in conjunction with a listing of one or more components or other items, are each to be construed as open-ended, meaning that the listing is not to be considered as excluding other, additional components or items. Other terms are to be construed using their broadest reasonable meaning unless they are used in a context that requires a different interpretation.

What is claimed is:

1. A method of treating exhaust in a vehicle, comprising:
providing a catalytic converter in an exhaust tailpipe and an oxygen sensor downstream of the catalytic converter, the catalytic converter configured to reduce a concentration of a nitrogen oxide (NOₓ) present in an exhaust flow through the catalytic converter;
predicting an increase in an oxygen concentration within the catalytic converter based upon at least one or more real-time vehicle operating parameters, wherein the increase is predicted before a corresponding increase in oxygen concentration is measured by the downstream oxygen sensor; and
adjusting an air-fuel ratio of an engine of the vehicle based upon the predicted increase in oxygen concentration, thereby at least partially preventing the corresponding increase in the oxygen concentration.

2. The method of claim 1, wherein adjusting the air-fuel ratio of the engine enriches the air-fuel ratio of the engine.

3. The method of claim 1, wherein the air-fuel ratio is adjusted before the corresponding increase in oxygen concentration occurs.

4. The method of claim 1, wherein the one or more real-time vehicle operating parameters include at least a pressure ratio of the engine, an air mass per cylinder of the engine, an engine speed, and the air-fuel ratio of the engine.

5. The method of claim 4, wherein the one or more real-time vehicle operating parameters additionally include at least an upstream oxygen temperature, a rate of change in the engine pressure ratio, a rate of change of the air mass per cylinder of the engine, and a rate of change of the engine speed.

6. The method of claim 1, wherein the predicted oxygen concentration is modeled based upon an emission test associated with the engine.

7. The method of claim 6, wherein the emission test includes correlating a change in NOx production with the one or more real-time vehicle operating parameters.

8. The method of claim 7, wherein the one or more real-time vehicle operating parameters include at least one of a pressure ratio of the engine, an air mass per cylinder of the engine, an engine speed, and the air-fuel ratio of the engine.

9. The method of claim 8, wherein the one or more real-time vehicle operating parameters additionally include at least an upstream oxygen temperature, a rate of change in the engine pressure ratio, a rate of change of the air mass per cylinder of the engine, and a rate of change of the engine speed.

10. The method of claim 1, wherein the adjusting of the air-fuel ratio of the engine of the vehicle prevents the corresponding increase in the oxygen concentration.

11. The method of claim 1, wherein the adjusting of the air-fuel ratio of an engine of the vehicle based upon the predicted increase in oxygen concentration reduces an increase in NOx concentration caused by the corresponding increase in oxygen concentration.

12. A method of treating exhaust in a vehicle, comprising:
providing a catalytic converter in an exhaust tailpipe and an oxygen sensor downstream of the catalytic converter, the catalytic converter configured to reduce a concentration of a nitrogen oxide (NOₓ) present in an exhaust flow through the catalytic converter;
predicting an increase in an oxygen concentration within the catalytic converter based upon one or more real-time vehicle operating parameters before a corresponding increase in oxygen concentration is measured by the downstream oxygen sensor; and
at least partially preventing the increase in oxygen concentration before the corresponding increase in oxygen concentration occurs, based upon the predicted increase in oxygen concentration using the one or more real-time vehicle operating parameters.

13. An exhaust system for a vehicle, comprising:
a catalytic converter positioned in an exhaust tailpipe, the catalytic converter configured to reduce a concentration of a nitrogen-oxide (NOₓ) present in an exhaust flow through the catalytic converter;
an oxygen sensor in the tailpipe, the oxygen sensor positioned downstream of the catalytic converter; and
a processor in communication with at least one real-time vehicle operating parameter measured at the vehicle, the processor configured to predict an increase in an oxygen concentration within the catalytic converter based upon the at least one real-time vehicle operating parameter before a corresponding increase in oxygen concentration is measured by the downstream oxygen sensor, the processor configured to adjust an air-fuel ratio of an engine of the vehicle based upon the predicted increase in oxygen concentration.

14. The exhaust system of claim 13, wherein the processor is configured to respond to the predicted oxygen concentration increase by enriching the air-fuel ratio of the engine.

15. The exhaust system of claim 13, wherein the processor is configured to respond to the predicted oxygen concentration increase by adjusting the air-fuel ratio of the engine before the corresponding increase in oxygen concentration occurs.

16. The exhaust system of claim 13, wherein the predicted oxygen concentration is modeled based upon an emission test associated with the engine, wherein the emission test correlates changes in NOx production with the one or more real-time vehicle operating parameters.

17. The exhaust system of claim 16, wherein the correlated changes in NOx production are stored in a memory of the processor.

18. The exhaust system of claim 16, wherein the one or more real-time vehicle operating parameters include at least one of a pressure ratio of the engine, an air mass per cylinder of the engine, an engine speed, and the air-fuel ratio of the engine.

19. The exhaust system of claim 18, wherein the one or more real-time vehicle operating parameters additionally include at least an upstream oxygen temperature, a rate of change in the engine pressure ratio, a rate of change of the air mass per cylinder of the engine, and a rate of change of the engine speed.

20. The exhaust system of claim 13, wherein the catalytic converter is configured to reduce NOx concentration in an exhaust flow received from a gasoline engine.
